(19) United States
(12) Patent Application Publication
(10) Pub. No.: US 2008/0295942 A1
(43) Pub. Date: Dec. 4, 2008

(54) Optimized Support Element

(75) Inventors: Jean-Charles Lacour, Clermont-Ferrand (FR); Sebastein Rigo, Clermont-Ferrand (FR); Denis Morin, Bouzel (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., Granges-Paccot (SW)

(21) Appl. No.: 11/996,242

(22) PCT Filed: Jul. 19, 2006
(86) PCT No.: PCT/EP2006/064405

§ 371 Date: Jun. 10, 2008

(30) Foreign Application Priority Data
Jul. 19, 2005 (FR) 0507791

(51) Int. Cl. B60C 17/04

(52) U.S. Cl. 152/520

(57) ABSTRACT

Support element designed to be fitted to a rim inside a vehicle tire, for supporting the tread of this tire in the event of loss of inflation pressure, including a base, a cover and an annular body in which each supporting partition of the annular body is in the form of an oblique parallelepiped with two circumferentially oriented outer faces arranged on either side of said support element and two faces inclined relative to the circumferential direction by an angle α, two adjacent supporting partitions form a V-shaped pattern, and, at the base of the V, two adjacent supporting partitions are separated by a narrow axial slit extending radially through the whole of the annular body.

### BACKGROUND OF THE INVENTION

1. Field of the Invention

The present invention relates to support elements for vehicle tires designed to be fitted on their rims inside the tires to support the load in the event of failure of the tire or abnormally low pressure.

2. Prior Art

Document WO2005/044598 discloses a support element designed to be fitted to a rim inside a vehicle tire, for supporting the tread of this tire in the event of loss of inflation pressure, comprising:
an approximately cylindrical base designed to fit around the rim,
an approximately cylindrical cover designed to be in contact with the inside of the tire underneath the tread in the event of loss of pressure, leaving a gap between itself and the inside of the tread at the nominal operating pressure of the tire, and
an annular body connecting the base to the cover, said body consisting of a plurality of generally radial supporting partitions distributed around the circumference of the support element and extending generally axially to either side of the support element, in which element the supporting partitions have in their central portion two axially oriented circumferentially offset segments connected by an inclined segment and are each connected to the one before and the one after by joining parts extending approximately circumferentially and interrupted by very narrow axial slits, the purpose of the slits being to facilitate sagging of the partitions if the tire hits a pothole or a pavement.

### SUMMARY OF THE INVENTION

The subject of the invention is a similar support element whose operation in the event of an impact is further improved without loss of performance when running on a flat tire.

The support element according to the invention is characterized in that:
each supporting partition is in the form of an oblique parallelepiped with two circumferentially oriented outer faces arranged on either side of said support element and two faces inclined relative to the circumferential direction by an angle α,
in that two adjacent supporting partitions form a V-shaped pattern, and
in that two adjacent supporting partitions are separated at the base of the V by a narrow axial slit extending radially through the whole of the annular body.

The advantage of the support element according to the invention is that its behaviour when it hits a pothole or a pavement or the like, in other words a localized impact with an approximately axially oriented indenter, is much smoother than the support element of document WO2005/044598. The reason for this is that, when such an impact falls in the middle of a partition in the support element of WO2005/044598, its resistance to sagging is very high and when the impact falls on an axial slit its resistance is much less.

“Narrow” is used here to mean that the width in the circumferential direction between two adjacent partitions is much less than the radial height of an annular body. It is this that ensures that when rolling at low pressure or zero pressure, the partitions lean against each other.

In a preferred embodiment, the support element according to the invention is such that each supporting partition has a central portion in the form of an oblique parallelepiped extended by two lateral portions of right-angled trapezium shape with an axial face, of given axial width, termed the shoulder face, for pressing against a similar shoulder face of the lateral portion of the circumferentially adjacent supporting partition, a circumferential outer face, and a face inclined relative to the circumferential direction by an angle α, which continues on from the inclined face of the central portion of said supporting partition.

This embodiment makes the behaviour of such a support element even smoother in the event of an impact regardless of the azimuth of the impact. It also has the advantage of providing a more even pressure contact between the support element cover and the crown of the tire when running on a flat. This means that the lubricants in the cavity formed by the tire and rim to facilitate running on a flat are not expelled from the tire/support element cover interface when running on a flat.

Each partition may also have at least one lateral portion extended axially by a complementary portion of approximately parallelepiped form with a shoulder face which continues on from the shoulder face of the adjacent lateral portion and a circumferential outer face whose cross section is identical to the outer face of said adjacent lateral portion.

This complementary lateral portion means that the circumferential width of the outer faces of the partitions does not become too small, as this would make the load-bearing capacity of the lateral portions insufficient.

Advantageously, the circumferential width of the outer faces l is such that:

$$l \geq \frac{2}{3} e$$

where the thickness of the central portion of the partitions is e. Also, the axial width of said shoulder faces L is such that:

$$L \geq \frac{4}{3} e$$

where the thickness of the central portion of the partitions is e.

These values optimize the geometry of the partitions so that they have a sufficiently smooth response in the event of impacts and also when rolling on a flat.

In order for the partitions to resist impacts as one but always in a coordinated manner when running on a flat, it is advantageous for the width (d) in the circumferential direction of the slits to remain greater than two millimetres and less than 3 millimetres.

Preferably, where each slit is defined geometrically by a transverse profile obtained by cutting the slit on a cutting plane approximately at right angles to the mean direction of the slit, the transverse profile has curvatures (ρ) greater than one (1) mm at its radial ends.

The fact that the slits have at their radial end or ends a transverse profile with a curvature greater than 1 mm gives excellent fatigue behaviour at these ends. It has been found that with shorter curvatures, for example of around 0.5 mm, cracks can develop progressively when running on a flat at these radial ends of the slits or in the event of repeated impacts with corners for example.

It is advantageous for these curvatures to be such that:

$$\frac{d}{2} ≺ ρ ≺ d$$

in which d is the transverse width of the slits.

The support elements according to the invention are designed to be fitted to (and removed from) a rim comprising a support element platform by being pushed on axially by a rotary fitting roller of given diameter while the whole wheel, tire and support element assembly is being rotated. An example of such a fitting tool and the fitting method are disclosed for example in application EP 1 351 832 B1. To facilitate this fitting and removal, it is advantageous for the axial distance between the outer faces lying in the same meridian plane of two adjacent partitions to be less than the diameter of this fitting roller. A conventional value for the diameter of the fitting roller is 40 mm. If the support element has openings with a circumferential length greater than 40 mm, the fitting roller may push into these openings and thus fail to push the support element evenly onto the support element platform of the rim.

For convenience when making a support element according to the invention, the shape of the partitions, of the holding partitions and of the slits are advantageously designed to facilitate demoulding of the support element and include no undercut parts.

The constituent material of the support element according to the invention may be a rubber compound with a modulus of elasticity of between 10 and 40 MPa. It may also be a polyurethane elastomer with a modulus of elasticity of between 20 and 150 MPa. Another preferred material is a thermoplastic elastomer with a modulus of elasticity of between 20 and 150 MPa.

In a second embodiment of the support element according to the invention, this support element is such that it comprises an additional holding portion with a cover, a base and an annular body forming an axial extension on one side of the cover, the base and the annular body of the support element such that the annular body of the holding portion comprises a plurality of holding partitions which form an axial extension of a fraction of the supporting partitions of the support element.

A support element of this kind is particularly suitable for fitting to a wheel rim in such a way that the holding portion engages with the geometry of one of the seats to hold one of the tire beads on its seat.

In an advantageous embodiment, the V-shaped supporting partitions and holding partitions form generally Y-shaped patterns.

The invention also relates to an assembly consisting of a support element as described above and a wheel with a wheel rim comprising a first rim seat of maximum diameter Φ_{S1max}, and a second rim seat of maximum diameter Φ_{S2max} greater than the maximum diameter of said first seat Φ_{S1max}, said second seat being extended axially towards the first seat by a circumferential groove and a support element platform whose outside diameter is approximately equal to the maximum diameter of the first seat Φ_{S1max}, which assembly is characterized in that said wheel comprises a rim and a disc, the latter being connected to said rim on the same side as said second seat.

The advantage of this assembly over similar known assemblies is that it offers an additional gain in terms of penetration prevention which is related to the greater gap between the support element and the tire for the same maximum wheel diameter.

### BRIEF DESCRIPTION OF THE DRAWINGS

Other features and advantages of the invention will be found in the description given below with reference to the accompanying drawings, which show, as non-restrictive examples, a number of embodiments of the subject of the invention:

FIG. 1 is a side view of a support element;

FIG. 2 is an axial section through a wheel rim and through the element seen in FIG. 1;

FIG. 3 is a cross section AA as marked in FIG. 1 through a support element according to the invention;

FIG. 4, which is similar to FIG. 3, shows a cross section through a variant of a support element according to the invention;

FIG. 5, which is similar to FIG. 3, shows a cross section through a second variant of a support element according to the invention FIG. 6, which is similar to FIG. 3, shows a cross section through a second embodiment of a support element according to the invention;

FIG. 7 shows a transverse section through the radial end of a slot;

FIG. 8, which is similar to FIG. 2, shows an axial section through an element as seen in FIG. 6 fitted to a wheel;

FIG. 9 shows, in a partial perspective view, a cross section AA through a support element similar to that shown in FIG. 5; and

FIG. 10 is a diagram comparing the loads recorded at the centre of the wheel, as a function of the displacement, of a wheel and support-element assembly from FIG. 9 on a plane and on a representative indenter.

### DETAILED DESCRIPTION OF THE INVENTION

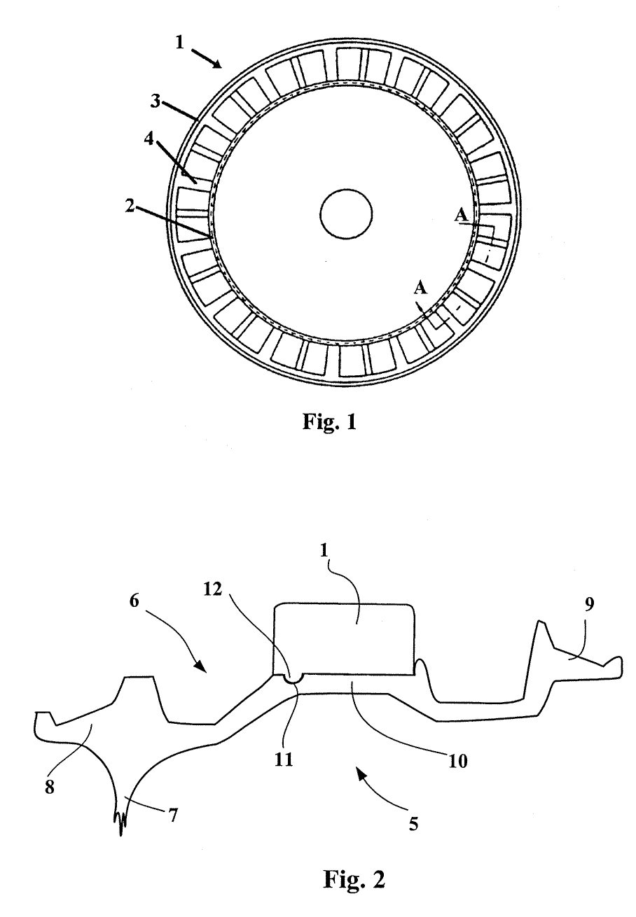

FIG. 1 is a side view of a support element 1 according to the invention. This element basically comprises three parts:
a base 2, of generally annular shape;
an approximately annular cover 3; and
an annular body 4 connecting the base 2 to the cover 3.

What is meant by generally or approximately annular is that the base and cover may include parts such as mounting blocks and sculpted parts (blocks, ribs) so that the geometry of the support element is locally non-annular, but designed to fit around an annular support element platform of the wheel.

This support element 1 is designed to be fitted around a wheel 5 with a preferred rim 6 as shown in FIG. 2, inside the cavity of a tire. A rim of this kind is described in particular in document EP 1 206 357. This rim 6 comprises an outer seat 8 and an inner seat 9. The two seats are of dissimilar diameters and the smaller-diameter seat is located on the outward side of the rim, that is to say adjacent to the region where the disc joins the rim. The rim also includes a support element platform 10 where the support element 1 is located. The support element platform comprises a circumferential slot designed to engage with a plurality of holding blocks 12 formed on the support element 1 to hold the support element in service on its platform 10.

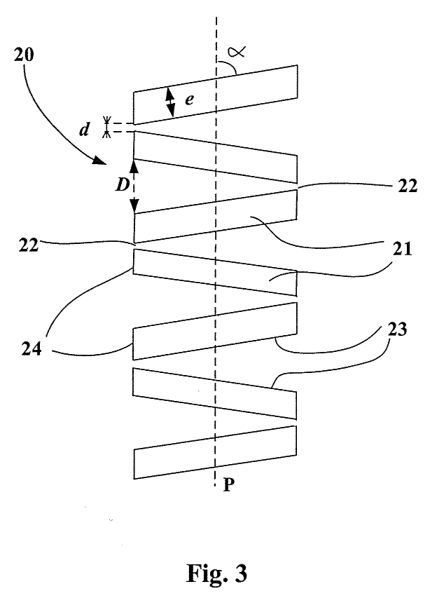

FIG. 3 shows an annular body 20. This figure is a sectional view AA as marked in FIG. 1. The annular body 20 consists of oblique parallelepiped partitions 21.

The partitions 21 extend laterally to either side of the circumferential mid plane P and are distributed at regular intervals around the circumference of the support element. These partitions 21 are inclined relative to the circumferential direction by an angle α of between 70 and 85° as a function of the axial width of the support element. Their thickness e is preferably constant. Two adjacent partitions have opposed inclinations relative to the axial direction and form a V-shaped pattern. The partitions 21 comprise two inclined faces 23 of inclination α relative to the circumferential direction and two circumferentially oriented outer faces 24. Two adjacent outer faces are separated on one axial side of the support element via a slit 22—this slit preferably having a circumferential distance D of from about 2 to about 3 mm; and on the other side, two adjacent outer faces 24 are separated by a maximum circumferential distance d so that the support elements can be fitted around the support element platform 10 without any problems. The reason for this is that, during this fitting, the support element is pushed on axially by a rotary fitting roller of given diameter. Such fitting rollers usually have a diameter of about 40 mm and this circumferential distance must be a maximum of 40 mm to ensure that during fitting the roller cannot push in between two adjacent partitions and thus damage these partitions and the support element. Consequently, the inclination of the partitions will be variable to suit the number of partitions and the axial width of the support element.

The dimensions of the partitions 21 are principally decided on the basis of the load which the support element is to carry and of the acceptable amount of deflection to carry this load. The number of partitions is also a factor, directly influencing the sag load of the partitions for a given stiffness. It is the volume of the partitions which thus determines the crush stiffness of the support element on a flat surface such as a road.

Another test is used to optimize the geometry of the support elements. This is the crush stiffness of the support element when fitted on its support element platform against a half-cylindrical indenter of diameter 80 mm. It has been found that such an indenter is representative of the crushing of a complete tire/support element/wheel assembly when impacting a transverse indenter such as a pavement or pothole.

To optimize the geometry of a support element, it is desirable to increase the ratio of the crush stiffness on a flat surface to the crush stiffness on this representative indenter, the latter crush stiffness being used in the least favourable conditions, meaning that the maximum stiffness is used as a function of the azimuth of the support element.

The support element presented in FIG. 3 has a ratio K substantially greater than 2.10. This support element has however a behaviour which is not sufficiently regular as a function of the azimuth.

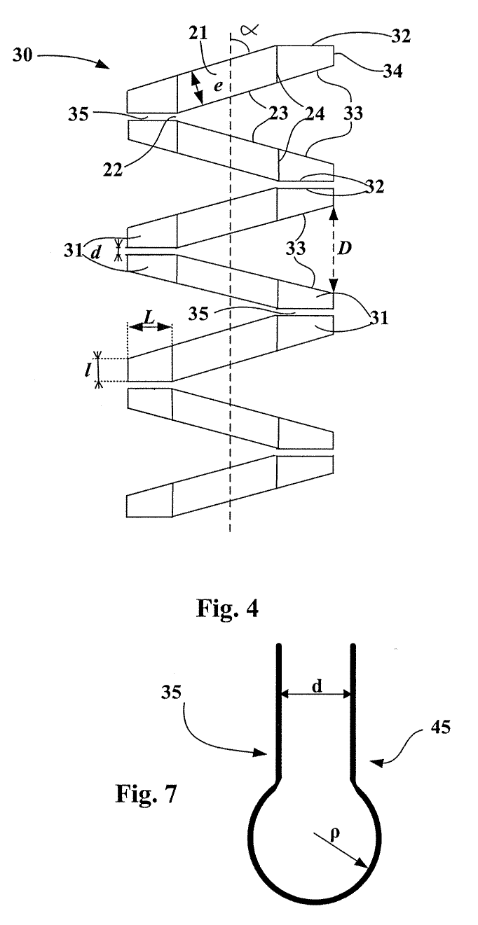

FIG. 4 shows an annular body 30 whose partitions comprise an oblique parallelepiped central portion 21 as before, but continued on either side of the two outer faces 24 by lateral portions 31 which are essentially right-angled trapezia. These lateral portions 31 comprise a face identical to the face 24, a circumferentially oriented outer face 34, an axially oriented face 32 termed the shoulder face, and an inclined face 33 which is a continuation of the face 23. As before, two adjacent partitions are separated on one axial side by a slit 35 whose circumferential distance is preferably between 2 and 3 mm, and on the other side by a circumferential distance D preferably less than or equal to the diameter of an ordinary fitting roller.

The addition of the right-angled trapezium-shaped lateral portions has two main advantages. It improves the rolling behaviour on the flat by enabling good contact between one pattern and the next because the shoulder faces are large enough. It also improves the smoothness of the behaviour in the event of a transverse impact.

The axial distance l of the outer faces 34 should preferably remain such that:

$$l \geq \frac{2}{3} e$$

in which e is the thickness of the partitions in their central portion.

Compliance with this limit ensures that the lateral portions have (and maintain) an effective complementary load-carrying role.

Similarly the axial length L of the shoulder faces 32 must be such that:

$$L \geq \frac{4}{3} e$$

This ensures good behaviour when rolling on a flat.

The optimized annular body of FIG. 4 significantly improves the corresponding support element's ratio K of the crush stiffness on the flat surface to that on a representative indenter. With a support element mostly made of a rubbery material, a factor of 2.5 can be achieved and exceeded.

A support element with so high a factor has the advantage, for a load of given dimensions, of sharply limiting the forces transmitted to the centre of the wheel by a violent impact for a given load-bearing capacity when running on a flat.

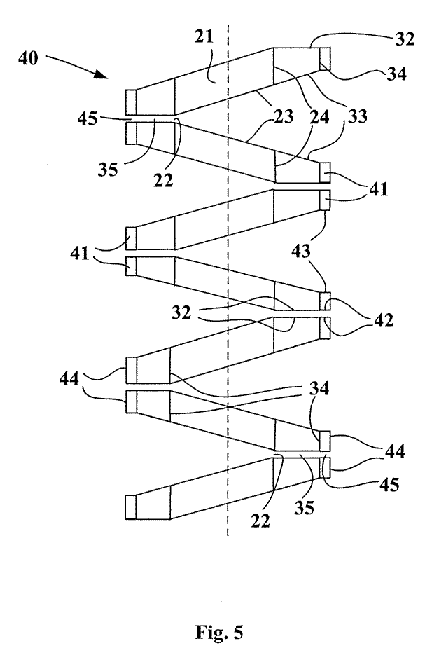

FIG. 5 shows an annular body similar to that of FIG. 4 in which the lateral portions are extended by a complementary portion 41 of parallelepiped shape. These complementary lateral portions comprise an outer face 44 identical in cross section to the face 34, a complementary shoulder face 42 which is an axial extension of the face 32, and a face 43 parallel to 42 and continuing on from the face 33. The benefit of this complementary lateral portion 41 is that it enables the abovementioned limits for l and L to be complied with in certain configurations of thickness, inclination and axial width of the partitions and of the support element.

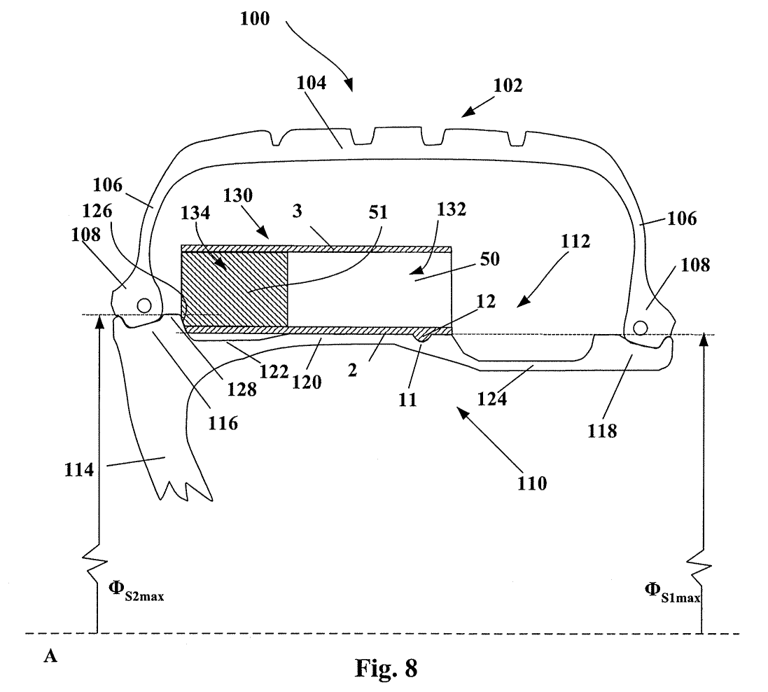

A second embodiment of a support element according to the invention is presented in FIGS. 6 and 8. These figures present a support element 130 which comprises a load-bearing portion 132 and an additional portion 134 for holding the tire bead. This support element 130 comprises an annular body 50. This annular body is shown in FIG. 6. It consists of partitions similar to those of FIG. 4 supplemented axially to one side of the support element by axial partitions 51. These axial partitions 51 are much thinner than the partitions 21. Their function is to connect the cover to the base with sufficient axial stiffness to allow engagement with a safety boss to hold a tire bead in position and remove the support element by pushing it off with a fitting roller. This portion of the annular body makes only a marginal contribution to load-bearing. The patterns of the partitions of the annular body 50 are thus roughly Y-shaped.

FIG. 8 illustrates a second assembly 100 consisting of tire 102, wheel 110 and support element 130 according to the invention. In this assembly the wheel 110 has, like that in FIG. 2, two seats of different maximum diameters Φ_{S1max}. It is distinguished from the wheel 5 of FIG. 2 in that the region where the disc 114 joins the rim 112 is on the side with the seat 116 of greater diameter Φ_{S2max}. The tire 102 has a tread 104, two sidewalls 106 and two beads 108 of different diameters for resting on the seats 116 and 118 of the rim 112. The rim 112 comprises a support element platform 120 around which there basically rests the load-bearing portion 132 of the support element 130 and, between the seat 116 and the support element platform 120, a circumferential groove 122. This circumferential groove 122 is designed to take the valve of the wheel and allow the bead 108 of the tire to be fitted onto and removed from the seat 116. The holding portion 134 of the support element 130 rests against the sidewall 126 of the circumferential groove 124 to engage with the safety boss 128 of the seat 116 and holds the tire 102 bead 108 in position.

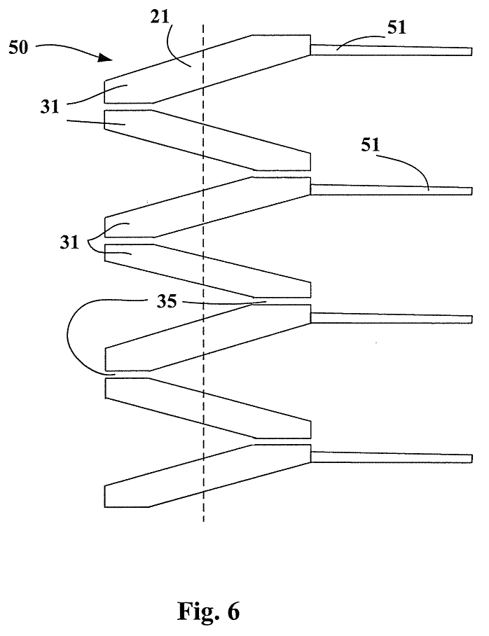

FIG. 7 shows an advantageous form of the transverse profile of the radial ends of the slits 35 and 45. This transverse profile is obtained by cutting the slit on a cutting plane effectively at right angles to the mean direction of the slit.

In FIG. 7 as in the previous figures, it will be seen that the transverse width d of the slit is approximately constant all the way up the radial height of the slit. This transverse width d is here approximately 2 to 2.5 mm. This profile has at its radial end an expansion of width greater than d. At this end the transverse profile has curvatures p greater than one millimetre. In the example of FIG. 7, the expansion is toroidal with a radius of approximately two mm.

Because the slits 35, 45 occupy the full radial height of the annular bodies, this expansion is situated at both the inner and outer radial ends of the slit.

The presence of these expansions significantly improves the rolling resistance on flat surfaces of the support element while maintaining excellent behaviour in the event of an impact with a corner, for example.

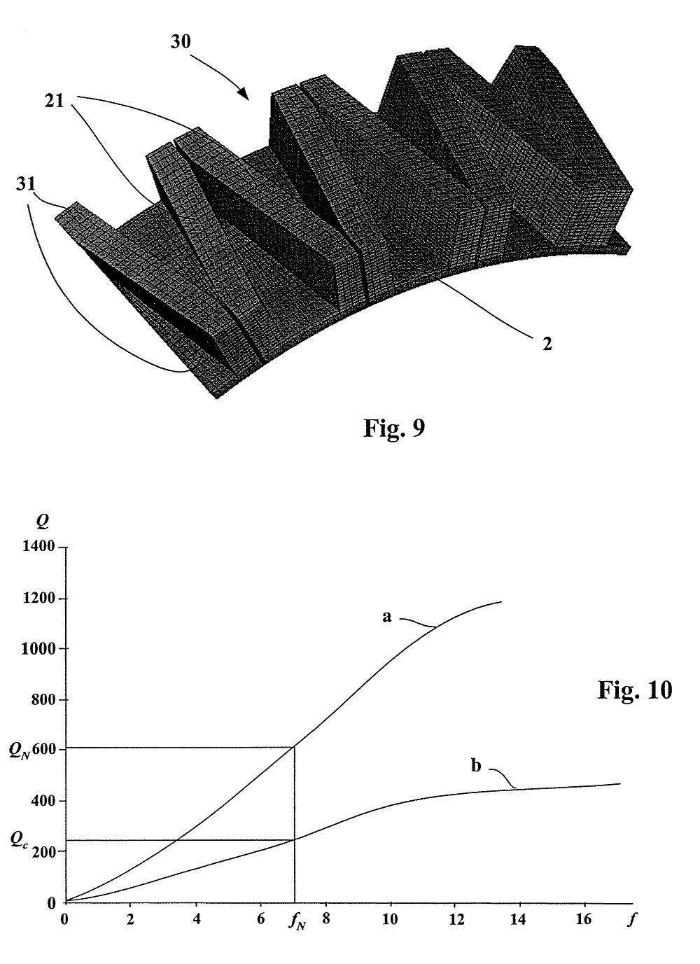

FIG. 9 is a partial perspective view at section AA of a support element similar to that of FIG. 5. The annular body 30 in this support element comprises a number of inclined oblique partitions 21 continued on either side by complementary portions in the form of right-angled trapezia 31. This figure also includes the base 2 of the support element. This base 2 has the same axial dimensions as the partitions of the annular body.

FIG. 10 illustrates the behaviour of the optimized support element shown in FIG. 9 when crushed on a flat surface at 80° C. (curve a) and on a half-cylindrical indenter of diameter 80 mm at 23° C. (curve b). Crushing is performed with the support element fitted on its service rim. The two curves a and b have an approximately linear first part followed by a maximum which corresponds to the partitions sagging.

The support element is designed to be crushed, on a flat surface with a defection ƒ_{N} under its service load Q_{N}. This design on a flat surface is preferably arrived at by considering the support element to be at its running temperature when running on a flat. This temperature is approximately 80° C. or even higher. When the support element is crushed onto the half-cylindrical indenter, for the same deflection ƒ_{N} is subjected to a load Q_{c}. The ratio Q_{N}/Q_{c} is equal to the ratio of the flat surface/indenter stiffnesses. The crush tests on the indenter are performed at ambient temperature. The stiffness ratio in question thus takes into account how the modulus of the material of the support element varies between ambient temperature and running temperature. This significantly impacts the values obtained for these ratios.

The flat/indenter stiffness ratio is here greater than 2.5:1 in the case of a support element made with a rubber compound.

This support element is thus optimized because of the fact that the regions of the partitions impacted in a transverse (or axial) impact are minimal and highly regular as a function of azimuth, and because the support element has high axial rigidity, which gives excellent behaviour and the distance D between two adjacent partitions allows easy fitting (and removal).

The invention is not limited to the examples described and illustrated and various modifications can be made to it without departing from its scope, which is limited only by the following claims.

What is claimed is:

1. A support element designed to be fitted to a rim inside a vehicle tire for supporting a tread of said tire upon loss of inflation pressure, said support element comprising:
an approximately cylindrical first base designed to fit around the rim,
an approximately cylindrical first cover designed to be in contact with the inside of the tire underneath the tread upon loss of pressure, wherein there is a gap between said first cover and the inside of the tire at a nominal operating pressure of the tire, and
a first annular body connecting the base to the cover, said body consisting of a plurality of generally radial supporting partitions distributed around the circumference of said support element and extending generally axially to either side of said support element,
wherein each supporting partition has a central portion in the form of an oblique parallelepiped having two circumferentially oriented outer faces arranged on either side of said support element and two faces inclined relative to the circumferential direction by an angle α,
wherein two adjacent supporting partitions form a V-shaped pattern,
wherein two adjacent supporting partitions are separated at a base of the V by a narrow axial slit extending radially through the first annular body, and
wherein the central portion of each supporting partition in the form of an oblique parallelepiped is extended by two lateral portions of right-angled trapezium shape having an axial shoulder face, of given axial width for pressing against a shoulder face of a lateral portion of a circumferentially adjacent supporting partition, a circumferential outer face, and a face inclined relative to the circumferential direction by an angle α, which continues on from the inclined face of the central portion of said supporting partition.

2. The support element according to claim 1, wherein each partition has at least one lateral portion extended axially by a complementary portion of approximately parallelepiped form having a shoulder face which continues on from the shoulder face of the adjacent lateral portion and a circumferential outer face whose cross section is identical to the outer face of said adjacent lateral portion.

3. The support element according to claim 1 or 2, wherein the circumferential width of said outer faces l is such that:
$$l \geq \frac{2}{3} e$$
where the thickness of the central portion of the partitions is e.

4. The support element according to claim 1, wherein the axial width of said shoulder faces L is such that:
$$L \geq \frac{4}{3} e$$
where the thickness of the central portion of the partitions is e.

5. The support element according to claim 1, wherein the width (d) in a circumferential direction of the slits is about two to about three millimetres.

6. The support element according to claim 1, wherein each slit is defined geometrically by a transverse profile obtained by cutting the slit on a cutting plane approximately at right angles to the mean direction of the slit, and wherein the transverse profile has curvatures (ρ) greater than one (1) mm at its radial ends.

7. The support element according to claim 6, wherein the curvatures (ρ) are such that:
$$\frac{d}{2} ≺ ρ ≺ d$$
where d is the transverse width of the slits.

8. The support element according to claim 1, wherein said support element is designed to be fitted to a support element platform of a wheel by a fitting roller of given diameter, and wherein the axial distance between the outer faces lying in the same meridian plane of two adjacent partitions is less than a diameter of said fitting roller.

9. The support element according to claim 1, wherein shapes of the partitions and shapes of the slits are designed to facilitate axial demoulding and wherein the slits include no undercut parts.

10. The support element according to claim 1, wherein a constituent material of said support element is a rubber compound with a modulus of elasticity of between 10 and 40 MPa.

11. The support element according to claim 1, wherein a constituent material of said support element is a polyurethane elastomer with a modulus of elasticity of between 20 and 150 MPa.

12. The support element according to claim 1, wherein a constituent material of said support element is a thermoplastic elastomer with a modulus of elasticity of between 20 and 150 MPa.

13. The supporting element according to claim 1, wherein said support element further comprises a holding portion with a second cover, a second base and a second annular body forming an axial extension on one side of the first cover, the first base and the first annular body of said support element and wherein the second annular body comprises a plurality of holding partitions which form an axial extension of a fraction of the supporting partitions of said support element.

14. The support element according to claim 13, wherein the V-shaped supporting partitions and the holding partitions form generally Y-shaped patterns.

15. The support element according to claim 13 or 14, designed to be mounted around a wheel rim, said wheel rim comprising a first rim seat of maximum diameter Φ_{S1max}, and a second rim seat of maximum diameter Φ_{S2max} greater than the maximum diameter of said first seat Φ_{S1max}, wherein said second seat is extended axially towards the first seat by a circumferential groove and a support element platform having an outside diameter approximately equal to the maximum diameter of the first seat Φ_{S1max}, wherein said supporting portion of said support element is designed to fit around said support element platform and wherein said holding portion is designed to be positioned radially outwardly relative to said circumferential groove.

16. The support element according to claim 15, wherein said second seat extends towards the first seat by a sidewall of said circumferential groove, and wherein said holding portion of said support element is designed to press against said sidewall of said groove.

17. The support element according to claim 15, wherein said wheel comprises a rim and a disc, and wherein the disc is connected to said rim on the same side as said second seat.

18. An assembly consisting of a support element according to claim 1 and a wheel having a wheel rim comprising a first rim seat of maximum diameter Φ_{S1max}, and a second rim seat of maximum diameter Φ_{S2max} greater than the maximum diameter of said first seat Φ_{S1max}, wherein said second seat is extended axially towards the first seat by a circumferential groove and a support element platform having an outside diameter approximately equal to the maximum diameter of the first seat Φ_{S1max}, wherein said wheel comprises a rim and a disc, and wherein the disc is connected to said rim on the same side as said second seat.
